(19) United States
(12) Patent Application Publication
(10) Pub. No.: US 2026/0135448 A1
(43) Pub. Date: May 14, 2026

(54) METHOD FOR PRODUCING A STATOR OF AN ELECTRIC ROTARY MACHINE, ELECTRIC ROTARY MACHINE STATOR PRODUCED BY SAID METHOD, AND ELECTRIC ROTARY MACHINE

(71) Applicant: Schaeffler Technologies AG & Co. KG, Herzogenaurach (DE)

(72) Inventors: Florian Sell-Le Blanc, Karlsruhe (DE); Nico Langberg, Neustrelitz (DE)

(73) Assignee: Schaeffler Technologies AG & Co. KG, Herzogenaurach (DE)

(21) Appl. No.: 19/119,225

(22) PCT Filed: Sep. 7, 2023
(86) PCT No.: PCT/DE2023/100661

§ 371 Date: Apr. 8, 2025

(30) Foreign Application Priority Data
Oct. 11, 2022 (DE) 10 2022 126 271.5

(51) Int. Cl. H02K 15/068; H02K 1/16; H02K 3/38; H02K 15/026; H02K 15/10

(52) U.S. Cl. CPC H02K 15/068; H02K 1/16; H02K 3/38; H02K 15/026; H02K 15/10

(57) ABSTRACT

A method for producing a stator of an electric rotary machine wherein a stator body having grooves for receiving portions of conductor elements of windings is provided, at least one first conductor element winding of a first phase is provided outside the stator body and has multiple first bights of bundled first conductor elements, a first insulating element is fixed to at least one first bight an adhesive connection, wherein each first bight is assigned at least one first insulating element, and the first conductor element winding is inserted into first grooves of the stator body, wherein the adhesive connection has the effect that the first insulating element is carried along with the movement of the first conductor element winding and is positioned relative to the stator body.

The method makes it possible for conductors of different phases of the stator to be more easily, less expensively and more reliably electrically insulated with respect to one another in the winding head.

### CROSS-REFERENCE TO RELATED APPLICATIONS

This application is the U.S. National Phase of PCT Appln. No. PCT/DE 2023/100661, filed Sep. 7, 2023, which claims the benefit of German Patent Appln. No. 102022126271.5, filed Oct. 11, 2022, the entire disclosures of which are incorporated by reference herein.

### TECHNICAL FIELD

The present disclosure relates to a method for producing a stator of an electric rotary machine, to an electric rotary machine stator produced by said method, and to an electric rotary machine that has the stator.

### BACKGROUND

Stators of electrical rotary machines have multiple phases, which are realized by windings running in different directions in the stator body.

FIG. 1 shows an example of a first conductor element winding 21, which is intended to form a first phase of a stator to be produced of an electric rotary machine. The individual conductor elements are arranged in bundles 22, which form first bights 30 on their radial outer sides. These first bights 30 rest on a coil plate. It must be ensured that the first phase or its conductor elements are insulated from further phases or their conductor elements. Phase separators are usually used for this purpose, which have to be placed manually in an otherwise automated production process. Depending on the product design, a separation of the electrical potentials within a phase may also be necessary, for example if the beginning and end of the phase are adjacent in the stator. This is particularly relevant in the event of a phase star connection, since higher potential differences form in the winding head portion. For the sake of simplicity, these insulation tasks are also referred to as phase separators in the following, even if the actual insulation takes place within an electrical phase. In the state of the art, the produced winding heads of the retracted winding must be spread open with specific tools, e.g., setting irons, in order to be able to arrange the phase separators at the desired position by manual insertion.

In an automated approach, retracted coils must be specially formed using robot handling. The phase separators can be used automatically after each coil has been inserted, although this operation must be carried out in a separate processing station. In addition, it is necessary to bring the phase separator into a three-dimensional shape, for example by folding the phase separator over.

Coherent phase separators in the form of cap-like insulating elements for the groove and winding head of a stator are known, as disclosed, for example, in the document CN203984116U, which can be mounted accordingly and with a method according to the document U.S. Pat. No. 4,831,715.

For this purpose, U.S. Pat. No. 4,831,715 A discloses a coil positioning machine for positioning coil separators in grooves. The insulators are positioned radially outward in grooves before the electrical conductors are arranged there.

In an alternative embodiment, end plates are arranged on stators, which provide different chambers for the individual phases and thus realize phase isolation.

For the automation of the assembly of phase separators, gripper systems as published in the document DE 102019105308B4 are known, which enable the coil to be shaped and assembled separately after it has been retracted. However, accessibility for assembly is then reduced, especially in the case of a multi-phase retraction.

Furthermore, it is known to position insulating elements in relation to the windings before retracting conductor elements of windings, which are carried along in the retraction movement of the windings and realize an insulation effect between the windings or the phases formed thereby. Such insulating elements are designed, for example, as rings which, when positioned, follow the circumferential arrangement of the grooves of the stator.

These rings are used for a mixed-phase retraction when several phases or their windings are retracted into the stator body with one retraction. These rings are placed on the retraction mandrel after the winding of the first phase. After winding another phase or its winding, the ring is fixed and is also retracted when the windings are retracted.

However, this means that only continuous insulation can be realized in the winding head. Due to the continuous ring shape, a circumferential phase separator takes up more space in the installation space of the winding head than separately mounted insulating elements that are used in places with critical potential differences.

### SUMMARY

On this basis, the underlying task of the present disclosure is to provide a method for producing a stator of an electric rotary machine, to an electric rotary machine stator produced by said method, and to an electric rotary machine, through which conductors of different phases of the stator to be more easily, less expensively and more reliably electrically insulated with respect to one another in the winding head.

This object is achieved by the method for producing a stator of an electric rotary machine, by the electric rotary machine stator produced by said method and by the electric rotary machine disclose herein.

The features of the claims can be combined in any technically meaningful way, it also being possible to make reference for this purpose to the explanations from the following description and features from the figures which include supplementary embodiments of the disclosure.

The disclosure relates to a the method for producing a stator of an electric rotary machine, in which a stator body having grooves for receiving portions of conductor elements of windings is provided, at least one first conductor element winding of a first phase is provided outside the stator body, which has multiple first bights of bundled first conductor elements, and a first insulating element is fixed to at least one first bight by means of an adhesive connection, wherein each first bight is assigned at least one first insulating element. The first conductor element winding is inserted into first grooves of the stator body, wherein the adhesive connection has the effect that the first insulating element is carried along with the movement of the first conductor element winding and is positioned relative to the stator body.

Accordingly, it can be provided to arrange insulating elements on one side of the stator body, such as on the side of the electrical connections of the stator, the so-called A-side, before the retraction and to position them in the winding head during retraction. The provision of the first conductor element winding of the first phase outside the stator body is optionally carried out on a positioning element, which can also be referred to as a retraction mandrel. Here, the first conductor element winding extends through clearances or through radial opening slots.

A bight is formed by several bundled, arch-shaped conductor portions. The first insulating element is fixed to a first bight by adhering the first insulating element to at least one conductor element of the bight by means of an adhesive connection.

An approved and standardized surface insulation material can be used as the material of the insulating element, which is provided with adhesive to create the adhesive connection. In an advantageous embodiment, the selected surface insulation material is able to adapt as easily as possible to the resulting shape of the bight in the stator during the assembly process. The selected insulation material must meet the appropriate product requirements in terms of temperature resistance and dielectric strength.

The insulating elements provide a separating effect between adjacent conductors of different phases of the stator or within a phase. In other words, by covering bights of conductor elements with the insulating elements, these are isolated from other conductor elements of other windings of the stator by a mechanical separation.

The insulating elements also fix the conductor elements in a respective bight in relation to one another, whereby the individual conductor elements are kept in a relatively ordered state and the retraction of the conductor elements into the grooves of the stator body is facilitated.

One embodiment of the described method provides that each first bight is assigned only one first insulating element.

Furthermore, at least one further conductor element winding of a further phase can be provided outside the stator body, which comprises multiple further bights in bundled further conductor elements, wherein a further insulating element is fixed to at least one further bight by means of an adhesive connection, and at least one further insulating element is assigned to each further bight. Depending on the process characteristics, it is also possible to use it in an assembly process in which coils of different phases are retracted rather than individual phases.

The further conductor element winding can be inserted into further grooves of the stator body, wherein the adhesive connection has the effect that the further insulating element is carried along with the movement of the further conductor element winding and is positioned relative to the stator body, such that insulating elements are arranged between overlapping portions of conductor element windings.

At least one insulating element is provided for each bundle of conductor elements present in a bight. Accordingly, when a phase is retracted, multiple insulating elements are moved and positioned.

In this way, bundles of conductor elements can be retracted into grooves of stators, whereby the bights remain on an axial outer side of the stator and can be insulated there by the insulating elements.

Before arranging the insulating elements, the conductor elements can be positioned on a positioning element, such as a retraction mandrel, such that the conductor elements in windings can extend through radial opening slots of the positioning element and can thereby meander between the radial inner side and the radial outer side of the substantially hollow cylindrical positioning element.

A retraction tool can retract the conductor elements into the grooves of the stator, wherein the positioning element can have the function of the retraction tool, or an extra tool can be used which transfers the bundles of conductor elements from the positioning element into the grooves of the stator.

This technique is applicable to the production of windings of a stator of an internal rotor machine, where the stator surrounds the rotor on its radial outer side. However, this should not exclude the production of windings of a stator of an external rotor machine in which the rotor surrounds the stator on its radial outer side.

The application of the method in the production of the winding of an axial flow machine should not be ruled out either, wherein the insulating elements can be arranged on the radially outer side and/or the radially inner side of the winding, assigned to the individual bights of the bundles of conductor elements at the bights realized there.

Furthermore, if the surface insulating element is shaped to match the transition contour of the winding, at least one of the insulating elements can be partially retracted into grooves of the stator body. In this embodiment of the method, the insulating effect by means of an insulating element extends not only to the area outside the grooves of the stator but also to a partial area of the grooves. In one embodiment, the contour of the insulating element has the inverse shape of the mounting space, such that, when mounting in the adjacent groove area, a strip must be provided on the end contour of the insulating element.

A respective first insulating element can be substantially two-dimensional and have a surface on one side, which is at most 18% of the size of the surface that covers the first bight in the plane of the course of the relevant first bight on its outer side prior to the insertion of the first conductor element winding belonging to the first bights into the grooves. A radially extending axis of symmetry of the insulating element can be positioned substantially centrally in relation to a center of the first bight.

In a preferred embodiment of the isolating element, there is a two-dimensional contour of the insulating element, which corresponds to the perpendicular projection of the bights onto a plane in which the bights run. Typically, this results in a simple U- or V-shape of the surface insulating element and a butterfly contour when the details are adjusted.

Each insulating element can be designed to be self-adhesive. After positioning the insulating element at the relevant bight and contacting it therewith, the element is appropriately fixed in place and no further effort is required for the final position of the insulating element, as it is carried along with the movement of the conductor elements and thus automatically brought into its end position.

The first insulating elements can be placed on a coil plate before assembly of the winding in the stator and before realization of the adhesive connections, and then the adhesive connections are made by pressing the first bights of the conductor elements onto the first insulating elements.

The adhesive connections are thus automatically realized when the insulating elements are in contact with the conductor elements of the bights, regardless of whether the insulating elements were previously placed on a coil plate or not.

The insulating elements can be guided to the process of producing the adhesive connection from a side of the bights facing away from the stator body.

In this case, the first insulating elements can be provided in one or more cassettes, which are open or can be opened on the side facing the stator body, for example by means of sliding closure means, so that the first insulating elements can be conveyed from the cassette or cassettes towards the bights in order to be fixed to them by means of the adhesive connections. The first insulating elements can be provided with an index for clear assignment to the respective bights or phases.

Such cassettes can, for example, be arranged in the coil plate such that the first insulating elements are conveyed to the bights in a vertical direction from bottom to top.

In an alternative embodiment, first insulating elements can be positioned automatically by a gripper that guides the first insulating elements between the bights and the coil plate.

Such a gripper can be combined with a conveyor device that conveys insulating elements close to the stator body, from where individual insulating elements are then assigned to the individual bights by means of the gripper. Such a gripper can also be used to position the start and end sections of the conductor elements and/or to shape the coils produced.

A respective insulating element, prior to the production of the adhesive connection, can have a shape which has a longer extension on a first radial side along the circumferential direction than on a second radial side along the circumferential direction.

For example, a first radial side may be a radially inner side and the second radial side may be a radially outer side. The circumferential direction or radial direction refers to the round cross-section of the stator body.

The insulating elements can be designed to be axially symmetrical with respect to a radially extending axis, so that they substantially resemble a butterfly shape overall. The method for producing a stator of an electrical rotary machine can be realized on the retraction mandrel or the positioning element for positioning the individual windings, or as an intermediate station between the winding station and the retraction station.

The advantages of the present method are that only bights in bundled conductor elements are insulated by means of the insulating elements, whereby the use of insulation material is comparatively low. The adhesive connections prevent any unintentional displacement of the insulating elements. The fact that insulating elements can be positioned immediately before the process of retracting the conductor elements or coils into the grooves of the stator further counteracts unintentional displacement. The insulating elements can still be placed very precisely, as there is still a relatively large amount of space available between the individual bights before retraction. The mechanical stress on the winding and the wire bundle is reduced by the space-saving assembly of the insulating element.

The insulating elements can be designed in such a way that they not only insulate bights of bundled conductor elements, but also connection regions of the conductor elements used.

The conductor elements can be retracted until there is mechanical contact between the respective insulating element and the stator body or other insulating elements of the winding, e.g., the groove insulation. The automated arrangement of the insulating elements enables consistent quality and low production costs.

It is not necessary to fix the insulating elements with another adhesive connection after the first or second retraction.

Furthermore, no re-forming or folding of the insulating elements is necessary, since the retraction of subsequent coils ensures that previously arranged insulating elements are positioned, fixed and formed in such a way that their shapes are complementary to adjacent coils or conductor elements or this is realized by the already existing process step of free-forming or final forming after the retraction of the coils or phases.

A further aspect of the present disclosure is a stator of an electric rotary machine, comprising a stator body having grooves and portions of conductor elements of windings received therein, which form bights outside the grooves, wherein insulating elements are fixed to the bights by means of adhesive connections and one insulating element is assigned to each respective bight.

One such stator was produced according to the present method. If the stator is designed such that at least one further insulating element is fixed to at least one bight by means of an adhesive connection, wherein only one further insulating element is assigned to each further bight, and the further conductor element winding is inserted into further grooves of the stator, insulating elements are arranged between overlapping portions of conductor element windings.

An electric rotary machine is also provided which has a described stator or has a stator produced according to the described method.

The disclosure described above is explained in detail below against the relevant technical background with reference to the associated drawings, which show preferred embodiments. The disclosure is in no way limited by the purely schematic drawings and it should be noted that the exemplary embodiments shown in the drawings are not limited to the dimensions shown. In the drawings:

### BRIEF DESCRIPTION OF THE DRAWINGS

FIG. 1: depicts a conventional arrangement of conductor elements of a first phase in perspective view,

FIG. 2: depicts an arrangement of conductor elements of a first phase with insulating elements according to the present method in perspective view,

FIG. 3: depicts detail A from FIG. 2 in an enlarged view,

FIG. 4: depicts a stator body equipped with insulating elements according to the present method in perspective view, and

FIG. 5: depicts an insulating element used according to the present method.

### DETAILED DESCRIPTION

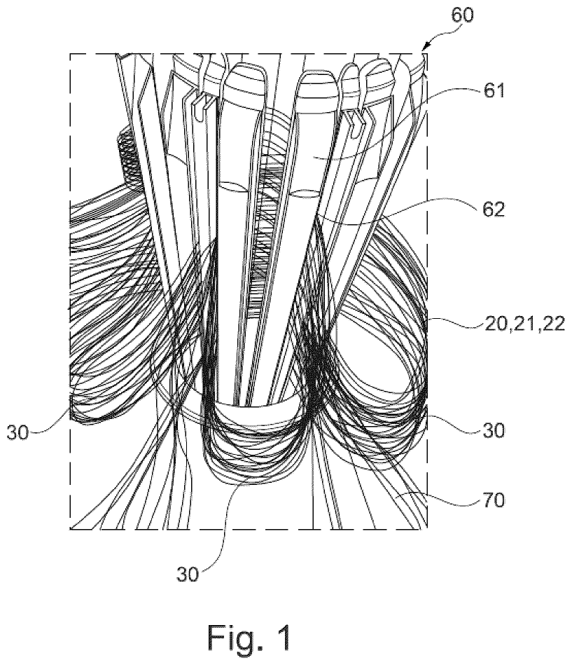

FIG. 1 has already been discussed in detail to explain the prior art.

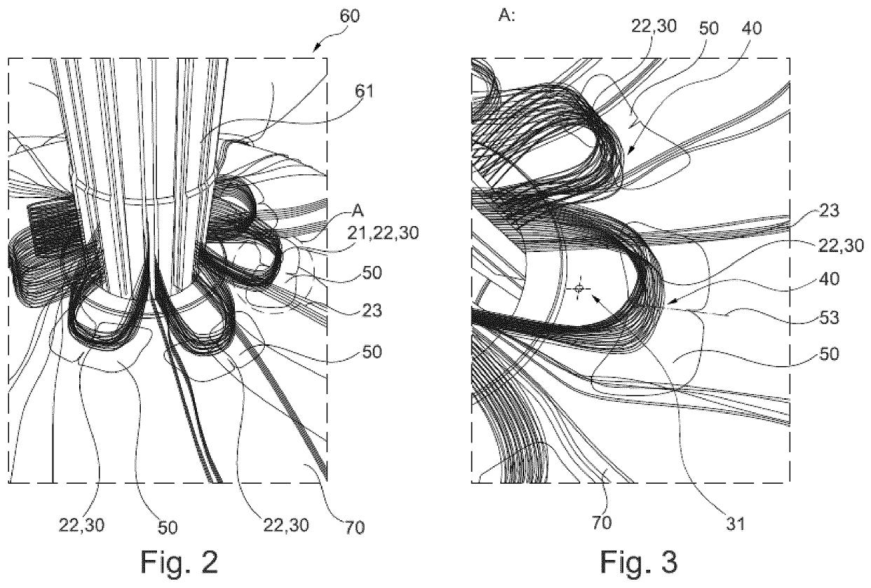

FIG. 2 shows a stage during the implementation of the present method for producing a stator of an electric rotary machine, in which a first conductor element winding 21 is provided with first insulating elements 50.

It can be seen that a first conductor element winding 21, which is a bundle of first conductor elements 22, is guided through radial opening slots 62 between retractable discs 61 of a positioning element 60, also known as a retraction mandrel. This first conductor element winding 21 thus forms a first phase 20 of the entire winding package to be produced of the stator to be produced.

Here, too, the individual conductor element of the first conductor element winding 21 are implemented in the first bights. In contrast to the embodiment shown in FIG. 1, however, there are first insulating elements 50 between the first bights 30 and the coil plate 70, wherein a first insulating element 50 is assigned to each first bight 30.

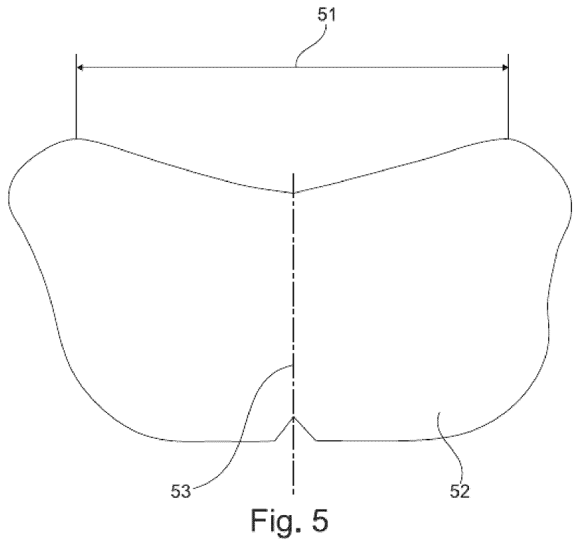

The first insulating elements 50 adhere to the first bights 30 or to individual conductor elements of the bundles 22 by means of adhesive connections 40, as indicated in FIG. 3. In FIG. 3, it is also evident that a center 31 of a respective first bight 30 lies approximately on a radially extending axis of symmetry of the respective first insulating element 50. This radially extending axis of symmetry of a first insulating element 50 is explained with reference to FIG. 5.

As can also be seen from FIGS. 2 and 3, the first insulating elements 50 not only cover individual first bights 30, but they also partially cover connection regions 23 of conductor elements which serve to electrically connect the winding.

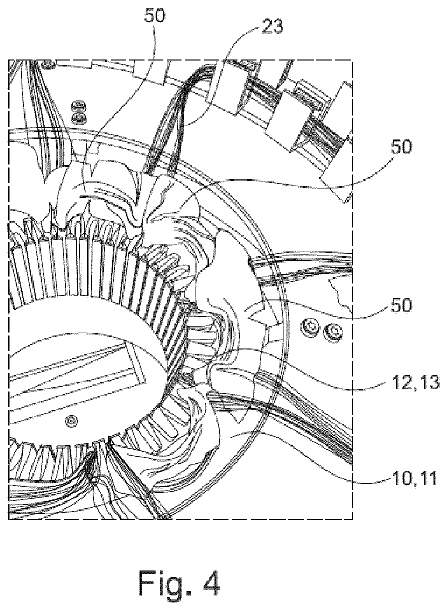

FIG. 4 shows a stator body 10 equipped according to the present method on its A-side 11, i.e. on the side on which the connection region 23 of conductor elements is realized. In the state shown here, conductor elements of the first phase (not visible here) have already been retracted into individual grooves 12 of the stator body 10. Furthermore, there are groove insulations 13 in the grooves 12.

It can be seen that the first insulating elements 50, which were previously arranged by means of an adhesive connection, have also moved up to the stator body 10 as a result of the winding being retracted, and are now positioned and fixed in an axial end region of the stator body 10. Furthermore, it can be seen that the first insulating elements 50 overlap one another in some areas in order to reliably ensure the insulation of the bundles 22 of first conductor elements located underneath.

After the first phase has been retracted here, further phases or their bundles of conductor elements can be retracted into the grooves 12 of the stator body 10. The first insulating elements that have already been arranged ensure that the conductor elements of the further phases do not contact the conductor elements of the first phase. Further conductor element windings can also be equipped with further insulating elements in order to also achieve an insulating effect among them.

FIG. 5 shows a first insulating element 50 in plan view. This first insulating element is substantially designed to be two-dimensional and has a somewhat butterfly shape 52. This means that the first insulating element 50 has a longer extension 51 on one radial side than on the radially opposite side. The first insulating element 50 is designed to be substantially symmetrical with respect to a radially extending axis of symmetry 53.

To explain the radial course of this axis of symmetry 53, reference is made to FIG. 3, where it can be seen that this axis of symmetry 53 runs radially in relation to the shape of the course of the first conductor element winding 21.

The method proposed here for producing a stator of an electric rotary machine makes it possible for conductors of different phases of the stator to be more easily, less expensively and more reliably electrically insulated with respect to one another in the winding head.

### LIST OF REFERENCE SYMBOLS

10 Stator body
11 A-side
12 Groove
13 Groove insulation
20 First phase
21 First conductor element winding
22 Bundle of first conductor elements
23 Connection region
30 First bight
31 Center of the first bight
40 Adhesive connectivity
50 First insulating element
51 Longer extension
52 Butterfly shape
53 Radially extending axis of symmetry
60 Positioning element
61 Retractable disc
62 Radial opening slot
70 Coil plate

1. A method for producing a stator of an electric rotary machine, the method comprising:
providing a stator body having grooves for receiving portions of conductor elements of windings;
providing at least one first conductor element winding of a first phase is outside the stator body, which has multiple first bights of bundled first conductor elements,
fixing a first insulating element to at least one first bight with an adhesive connection, wherein each first bight is assigned at least one first insulating element; and
inserting the first conductor element winding into first grooves of the stator body;
wherein the adhesive connection has the effect that the first insulating element is carried along with the movement of the first conductor element winding and is positioned relative to the stator body.

2. The method for producing a stator of an electric rotary machine according to claim 1, further comprising:
providing at least one further conductor element winding of a further phase outside the stator body, which comprises multiple further bights in bundled further conductor elements,
fixing a further insulating element is fixed to at least one further bight with an adhesive connection, wherein at least one further insulating element is assigned to each further bight, and
inserting the further conductor element winding into further grooves of the stator body,
wherein the adhesive connection has the effect that the further insulating element is carried along with the movement of the further conductor element winding and is positioned relative to the stator body, such that insulating elements are arranged between overlapping portions of conductor element windings.

3. The method for producing a stator of an electric rotary machine according 1 claim 1, wherein at least one of the insulating elements is drawn into grooves of the stator body in certain regions.

4. The method for producing a stator of an electric rotary machine according claim 1, wherein the first insulating element is substantially two-dimensional and has a surface on one side, which is at most 18% of the size of a surface that covers the first bight in a plane of the course of the relevant first bight on its outer side prior to the insertion of the first conductor element winding belonging to the first bights into the grooves.

5. The method for producing a stator of an electric rotary machine according claim 1, wherein the insulating element is designed to be self-adhesive.

6. The method for producing a stator of an electric rotary machine according to claim 1, wherein the first insulating elements are placed on a coil plate before realization of the adhesive connections, and then the adhesive connections are made by pressing the first bights of the conductor elements onto the first insulating elements.

7. The method for producing a stator of an electric rotary machine according to claim 6, wherein the insulating elements are guided to the process of producing the adhesive connection from a side of the bights facing away from the stator body.

8. The method for producing a stator of an electric rotary machine according claim 1, wherein a respective insulating element prior to the production of the adhesive connection, has a shape which has a longer extension on a first radial side along a circumferential direction than on a second radial side along the circumferential direction.

9. A stator of an electric rotary machine, comprising a stator body having grooves and portions of conductor elements of windings received therein, which form bights outside the grooves, wherein insulating elements are fixed to the bights with adhesive connections and at least one insulating element is assigned to each respective bight.

10. An electric rotary machine, comprising a stator having a stator body having grooves and portions of conductor elements of windings received therein, which form bights outside the grooves, wherein insulating elements are fixed to the bights with adhesive connections and at least one insulating element is assigned to each respective bight.

11. The stator of claim 9, wherein at least one of the insulating elements is received into grooves of the stator body in certain regions.

12. The stator of claim 9, wherein the insulating element is self-adhesive.

13. The electric rotary machine according to claim 10, wherein at least one of the insulating elements is received into grooves of the stator body in certain regions

14. The electric rotary machine according to claim 10, wherein the insulating element is self-adhesive.
